(19) United States
(12) Patent Application Publication
(10) Pub. No.: US 2024/0345659 A1
(43) Pub. Date: Oct. 17, 2024

(54) METHOD FOR USER GROUPING IN METAVERSE-BASED OFFICE ENVIRONMENT, STORAGE MEDIUM IN WHICH PROGRAM FOR EXECUTING SAME IS RECORDED, AND USER GROUPING SYSTEM INCLUDING STORAGE MEDIUM

(71) Applicant: ZIGBANG CO., LTD., Seoul (KR)

(72) Inventors: Dae Wook KIM, Anyang-si (KR); Dae Ho KIM, Seongnam-si (KR); Sung Chul JE, Siheung-si (KR); Do Haeng LEE, Yongin-si (KR); Yong Jae CHOI, Seongnam-si (KR)

(73) Assignee: ZIGBANG CO., LTD., Seoul (KR)

(21) Appl. No.: 18/756,581

(22) Filed: Jun. 27, 2024

Related U.S. Application Data
(63) Continuation of application No. PCT/KR2022/018854, filed on Nov. 25, 2022.

(30) Foreign Application Priority Data
Dec. 28, 2021 (KR) 10-2021-0189970

(51) Int. Cl. G06F 3/01; G06Q 50/00; G06T 19/00

(52) U.S. Cl. CPC G06F 3/013; G06Q 50/01; G06T 19/00; G06T 2207/30196

(57) ABSTRACT

The present invention relates to a method for user grouping in a metaverse-based office environment and, more particularly, to a method for user grouping in a metaverse-based office environment, the method comprising: a target user identification step of identifying a camera viewpoint of a local user in a virtual space, and identifying target users included in a virtual image of the camera viewpoint; and a user grouping step of grouping target users satisfying a configured grouping condition from among the target users, on the basis of avatar positions and gaze directions of the local user.

### CROSS-REFERENCE TO RELATED PATENT APPLICATION

This application is a continuation of International Application, PCT/KR2022/018854, filed on Nov. 25, 2022, which claims the benefit of Korean Patent Application No. 10-2021-0189970, filed on Dec. 28, 2021, in the Korean Intellectual Property Office, the disclosure of which is incorporated herein in its entirety by reference.

### TECHNICAL FIELD

The present disclosure relates to a user grouping method in a metaverse-based office environment and, more particularly, to grouping, when building a metaverse-based office environment in a three-dimensional virtual space, participants (users) connecting to the office environment.

In particular, the present disclosure relates to a user grouping method in a metaverse-based office environment in which users are allowed to automatically join and leave a chat group according to the movement and gaze of their characters (avatars) in a virtual space to thereby participate in a natural conversation like in real life.

### BACKGROUND ART

The term “metaverse” is a compound word of “meta”, meaning virtual or beyond, and “universe”, meaning world or space, and refers to a three-dimensional virtual world where social activities similar to the real world take place.

Metaverse is a concept that is one step further evolved than virtual reality (VR, a cutting-edge technology that allows people to have a realistic experience in a virtual world created on computers), and has the characteristic of using avatars to not only enjoy games or virtual reality, but also to engage in social and cultural activities among members (avatars) like in real life.

Meanwhile, virtual reality refers to a human-computer interface that creates a specific environment or situation with a computer so as to make it as if the person using it is interacting with the actual surrounding situation or environment.

This virtual reality is mainly intended to allow people to show and manipulate environments that are difficult to experience on a daily basis as if they were in the environment without directly experiencing it, and its application areas include games, education, advanced programming, remote manipulation, remote satellite surface exploration, exploration data analysis, and scientific visualization.

As a result, metaverse can be seen as creating a specific environment or situation using a computer and allowing social ties between users to be more active within this environment or situation.

Recently, as working from home has become more prevalent due to various reasons such as IT infrastructure, social advancement and health crisis, methods of performing work in this metaverse-based virtual office environment are being developed.

Meanwhile, online conversations (chatting) mainly take place in grouped chat spaces, and the method of forming a chat group is performed through requests/consents between users.

In other words, in an existing method of forming a chat group online, when a specific user requests another user desired to chat with to participate in a conversation, the other party checks it to decide whether to participate, and if the other party accepts the participation, a chat group is established.

Generally, conversation between persons in reality is not in the form of request/consent, but rather in the form of natural conversation between nearby people.

As described above, metaverse is a technology aimed at social activities in virtual space, and it may be seen that a difference in technology arises depending on how much of the virtual space has been realized.

Considering the technical characteristics of the metaverse field, it may be difficult to apply an online chat group formation method as previously known, to the metaverse field.

As a related art document, Korean Patent Gazette No. 10-1685564 entitled “Social Network Grouping Method and System, and Computer Storage Medium” (hereinafter referred to as “related art technique”) is a grouping technology for social network users, where grouping is performed according to the importance of individual friends.

However, this related art technique is a technology based on social networks, and as described above, it may be difficult to apply the related art technique to the metaverse field.

### DISCLOSURE

### Technical Problem

In order to solve the above-described problem, an object of the present disclosure is to provide a user grouping method in a metaverse-based office environment that is capable of grouping, when building a metaverse-based office environment in a three-dimensional virtual space, participants (users) connecting to the office environment.

In particular, an object of the present disclosure is to provide a user grouping method in a metaverse-based office environment in which users are allowed to automatically join and leave a chat group according to the movement and gaze of their characters (avatars) in a virtual space to thereby participate in a natural conversation like in real life.

More specifically, an object of the present disclosure is to provide a user grouping method in a metaverse-based office environment in which chat groups are formed based on spatial conditions in a virtual office environment such as distance between characters (avatars), configuration area, field of view, and structures and objects in the virtual space so as to enable more realistic formation of chat groups.

### Technical Solution

To achieve the above object, a method for grouping users in a metaverse-based office environment according to the present disclosure includes: a target user identification step of identifying a camera viewpoint of a local user in a virtual space and identifying target users included in a virtual image of the corresponding camera viewpoint; and a user grouping step of grouping those target users satisfying a configured grouping condition among the target users based on an avatar position and gaze direction of the local user.

In addition, the user grouping step may include: a field-of-view identification step of identifying a field of view based on the avatar position and gaze direction of the local user; and a condition-specific grouping step of grouping those target users satisfying the configured grouping condition among the target users included in the field of view.

In addition, the field-of-view identification step may include: a user list generation step of making a list of target users included in a current virtual image; a group formability check step of checking whether the target users included in the list are included in a group; a presence within gaze check step of checking whether a corresponding target user is present within the gaze direction and region of the local user; an object interference check step of checking interference caused by an object in the virtual space; a group inclusion check step of checking whether the corresponding target user belongs to a group together with the local user or has left a group; and a descending order sorting step of performing sorting in descending order according to the cosine similarity between a vector formed by the location of the corresponding target user and the location of the local user, and a vector viewed by the local user.

In addition, the condition-specific grouping step may include: a group candidate search step of searching for target users to be included in a chat group; a group candidate identification step of identifying a corresponding target user based on the search results of the group candidate search step; a group participation request step of making a group participation request to a target user being a corresponding group candidate; and a group participation step of maintaining, when group participation of the target user is identified, the group participation of the corresponding target user based on the configured grouping condition.

In addition, the group candidate identification step may search for a target user by checking whether the target user is present within the gaze of the local user; and the group candidate identification step may identify, in case that a target user is present within the gaze of the local user, the target user as a group candidate.

In addition, the group participation step may construct a minimum spanning tree by use of the local user and target users, check whether an edge count maintaining condition is satisfied with respect to the local user, and determine whether a specific target user remains in the group based thereon.

In addition, the condition-specific grouping step may further include: a new group search confirm step of confirming that a corresponding target user has found a more suitable group than the current group; a group leave request step of making, in case that the corresponding target user fails to satisfy the grouping condition of the current group or has identified a new group, a request to leave the current chat group; and a group leaving step of leaving the current chat group in response to the leave request.

In addition, the present disclosure includes a storage medium on which a program for executing the user grouping method in the metaverse-based office environment is recorded.

In addition, the present disclosure includes a user grouping system including the storage medium in a metaverse-based office environment.

### Advantageous Effects

Through the above solutions, the present disclosure has the advantage of grouping, when building a metaverse-based office environment in a three-dimensional virtual space, participants (users) connecting to the office environment.

In particular, the present disclosure has the advantage of allowing users to automatically join and leave a chat group according to the movement and gaze of their characters (avatars) in a virtual space and to participate in a natural conversation like in real life.

More specifically, the present disclosure has the advantage of forming chat groups based on spatial conditions in a virtual office environment such as distance between characters (avatars), configuration area, field of view, and structures and objects in the virtual space so as to enable more realistic formation of chat groups.

As a result, the present disclosure allows individual members (users) to connect online but may provide the same level of conversation as if they were talking face-to-face in the real world, thereby greatly enhancing the bond between members.

In addition, the present disclosure has the advantage of preventing problems such as information leakage from occurring in the process of transmitting information in advance by forming a chat group satisfying specific conditions among users connected to the virtual space and allowing conversation only within that chat group.

Therefore, it is possible to enhance reliability and competitiveness in the fields of metaverse, virtual reality and virtual office, as well as in similar or related fields.

### DESCRIPTION OF DRAWINGS

FIG. 1 is a flow diagram illustrating an embodiment of a user grouping method in a metaverse-based office environment according to the present disclosure.

FIG. 2 is a flow diagram illustrating a specific embodiment of step S200 shown in FIG. 1.

FIG. 3 is a flow diagram illustrating a specific embodiment of step S210 shown in FIG. 2.

FIG. 4 is a flow diagram illustrating a specific embodiment of step S220 shown in FIG. 2.

FIGS. 5 to 9 are diagrams describing FIG. 4 in more detail.

FIG. 10 is a flow diagram illustrating another embodiment of FIG. 4.

FIGS. 11 and 12 are diagrams describing FIG. 10 in more detail.

### MODE FOR DISCLOSURE

Examples of a user grouping method in a metaverse-based office environment according to the present disclosure may be applied in various ways, and the most preferred embodiment will be described below with reference to the attached drawings.

First, the user grouping matching method in a metaverse-based office environment of the present disclosure may be executed in a server/client system on the Internet, and the configuration for executing the method may be a stationary computing device such as desktop, workstation, or server, or may be a portable computing device such as smartphone, laptop, tablet, phablet, portable multimedia player (PMP), personal digital assistant (PDA), or e-book reader.

Additionally, the user grouping method in a metaverse-based office environment of the present disclosure may be executed in at least one configuration of a server or a client in a server/client system, and with at least two cooperating configurations, the process corresponding to the method may be divided and executed in a distributed manner according to an operational scheme. At this time, the client may include an administrator's terminal excluding the server as well as a user terminal used by the user.

In addition, technical terms used in the process of describing the present disclosure, unless specifically defined in a different way, should be interpreted as meanings generally understood by those skilled in the art to which the present disclosure pertains, and they should not be interpreted in a too comprehensive sense or in an excessively narrow sense.

In addition, if the technical term used to describe the present disclosure is an incorrect technical term that does not accurately express the idea of the present disclosure, it should be understood as being replaced with a technical term that can be correctly understood by a person skilled in the art.

In addition, general terms used in the present disclosure should be interpreted according to the definition in the dictionary or according to the context, and should not be interpreted in an excessively narrow sense.

In addition, singular expressions used to describe the present disclosure may include plural expressions, unless the context clearly indicates otherwise.

In addition, terms such as “include” or “have” should not be construed as necessarily including multiple components or multiple steps altogether, and should be interpreted that some of the components or steps may be not included or additional components or steps may be added.

In addition, the terms “1st” and “2nd” or “first” and “second” may be used to describe various components, but should be used to distinguish one element from another element without limiting corresponding elements in another aspect such as importance or order.

For example, a first component may be denoted as a second component, and vice versa, without departing from the scope of the present disclosure.

In addition, when a first element is referred to as being “coupled to” or “connected to” a second element, it may be coupled or connected to the second element directly or via a third element.

In contrast, it will be understood that when a first element is referred to as being “directly coupled to” or “directly connected to” a second element, no other element intervenes between the first element and the second element.

Hereinafter, when describing the present disclosure with reference to the attached drawings, identical or similar components will be assigned the same reference numbers throughout the drawings, and repeated descriptions thereof will be omitted.

In addition, when describing the present disclosure, related well-known functions or constructions may be not described in detail since they would obscure the gist of the present disclosure through unnecessary detail.

In addition, the attached drawings are only intended to facilitate easy understanding of the spirit of the present disclosure and should not be construed as limiting the spirit of the present disclosure, and the spirit of the present disclosure should be construed as extending to all changes, equivalents, or substitutes in addition to the attached drawings.

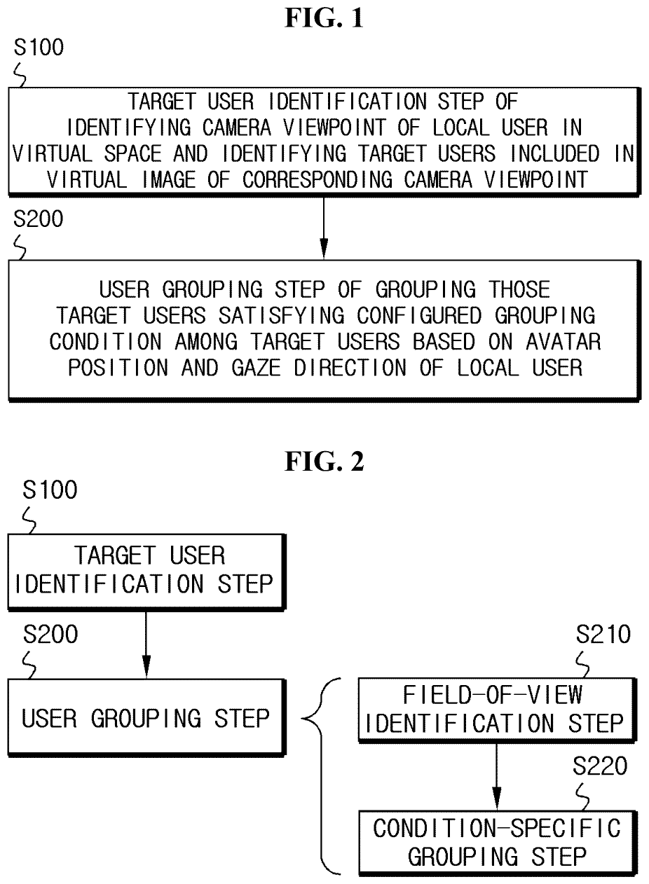

FIG. 1 is a flow diagram illustrating an embodiment of a user grouping method in a metaverse-based office environment according to the present disclosure.

With reference to FIG. 1, the user grouping method in a metaverse-based office environment includes a target user identification step (S100) and a user grouping step (S200).

The target user identification step (S100) is a process of identifying the camera viewpoint of the local user (also referred to as self-user) in the metaverse-based office environment (virtual space) and identifying users included in the virtual image of the corresponding camera viewpoint (other party, also referred to as group user, target user, or remote user), and may identify the camera viewpoint of the local user in the virtual space and identify the users included in the virtual image of the camera viewpoint.

Here, the camera viewpoint may be based on the local user's avatar or the rear upper part of the local user's avatar, the virtual space may be formed based on a three-dimensional coordinate system, and the virtual image is an image output to the user's terminal with respect to the camera viewpoint and refers to an image in which the three-dimensional coordinates of the virtual space are projected to two dimensions.

The user grouping step (S200) is a process of grouping those target users who satisfy configured grouping conditions among the target users based on the avatar position and gaze direction of the local user, which will be described in more detail below.

FIG. 2 is a flow diagram illustrating a specific embodiment of step S200 shown in FIG. 1.

With reference to FIG. 2, the user grouping step (S200) may include a field-of-view identification step (S210) and a condition-specific grouping step (S220).

The field-of-view identification step (S210) is a process of checking the field of view based on the local user's avatar position and gaze direction, and may include the direction in which the avatar is looking in the gaze direction, the camera viewpoint as seen by the user through the display, or the like.

The condition-specific grouping step (S220) is a process of grouping those target users who satisfy a configured grouping condition among the target users included in the field of view, and this will be described in more detail below.

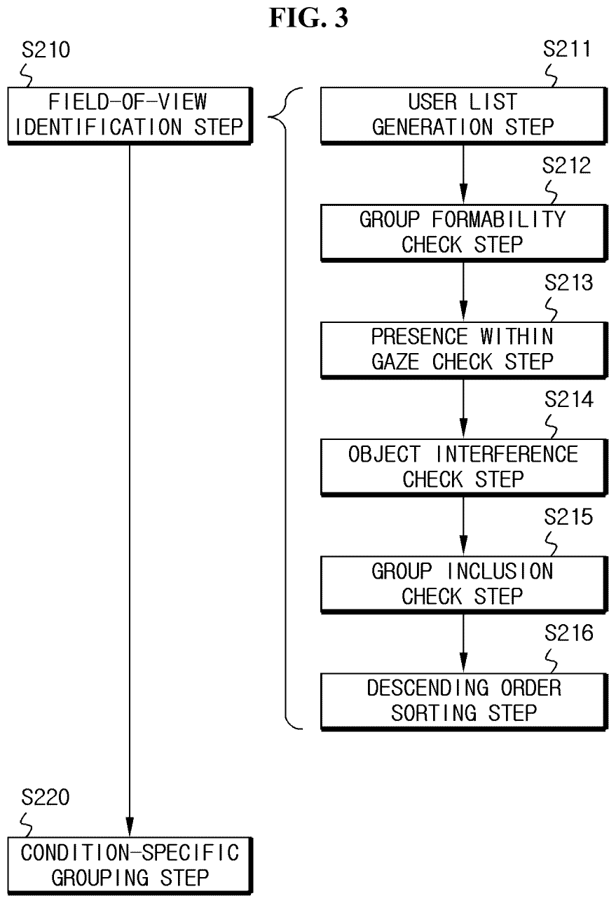

FIG. 3 is a flow diagram illustrating a specific embodiment of step S210 shown in FIG. 2.

With reference to FIG. 3, the field-of-view identification step (S210) may include a user list generation step (S211), a group formability check step (S212), a presence within gaze check step (S213), an object interference check step (S214), a group inclusion check step (S215), and a descending order sorting step (S216).

To be more specific, first, target users included in the current virtual image, that is, target users included in the camera viewpoint, may be identified and listed (S211), and whether target users included in the list are located within a distance to form a group may be checked to determine whether they can be included in a group, that is, whether they can be included in a chat group (S212).

Thereafter, whether the location of a corresponding target user is within the gaze direction and region viewed by the local user's avatar may be checked (S213), and whether the corresponding target user is interfered with by an object such as a wall in the virtual space may be checked (S214).

If the target user is present within the gaze direction and region of the local user and is not hidden by a wall or the like, whether the target user has already joined a group of the local user or has already left the group may be further checked (S215).

More specifically, it is possible to check whether the corresponding target user has already formed the same group (chat group) with the local user; if the target user is not included in the same group, it is possible to check whether the target user has been previously included in the corresponding group but then left.

If the corresponding target user is not in the same group with the local user and has never formed the same group before, such target users may be sorted in descending order according to the cosine similarity between the vector formed by the location of the target user and the location of the local user, and the vector viewed by the local user (S216).

Through this process, it is possible to identify users that can be grouped among the target users included in the local user's virtual image.

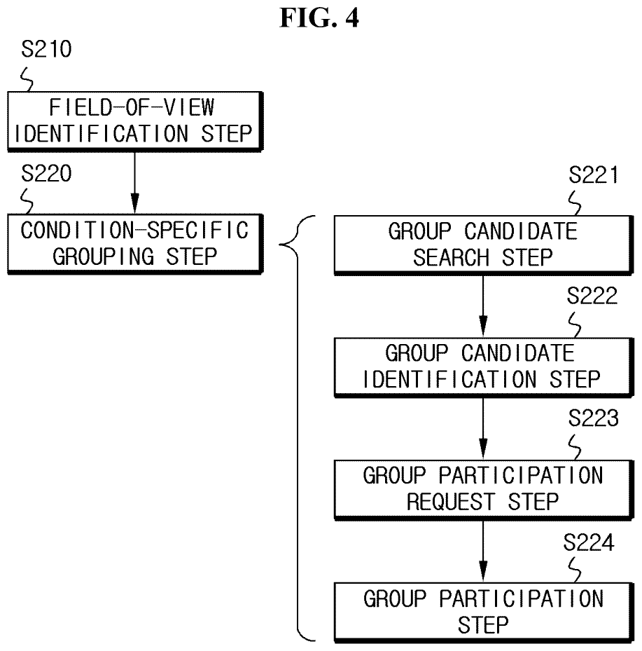

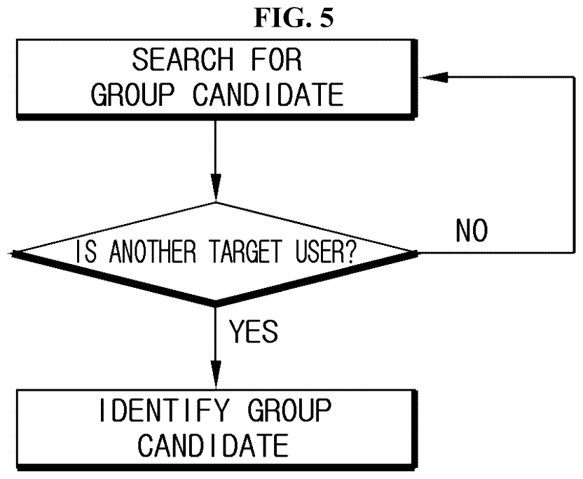

FIG. 4 is a flow diagram illustrating a specific embodiment of step S220 shown in FIG. 2. FIGS. 5 to 9 are diagrams describing FIG. 4 in more detail.

With reference to FIG. 4, the condition-specific grouping step (S220) may include a group candidate search step (S221), a group candidate identification step (S222), a group participation request step (S223), and a group participation step (S224).

The group candidate search step (S221) is a process of searching for target users to be included in the group, and may find target users by checking presence within the gaze of the local user, where the presence of a target user may be identified as shown in FIG. 5.

For example, as described above, a target user may be identified based on the list that is generated in the field-of-view identification step (S210) and is sorted in descending order.

The group candidate identification step (S222) is a process of identifying the target user based on the corresponding search results. If a target user is present within the gaze of the local user, the target user may be identified as a group candidate.

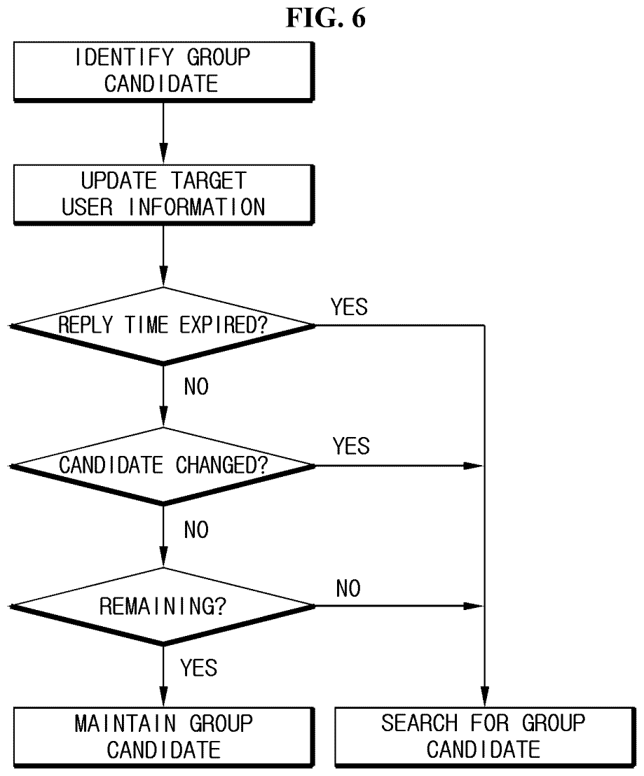

To be more specific, first, as shown in FIG. 6, after a group candidate is identified, the information of the corresponding target user is updated with the latest information. At this time, if the target user already belongs to another group, the latest information may include information on the group to which the target user belongs.

Thereafter, if the reply time expires or the candidate to participate in the group within the field of view is changed, a search for group candidate may be initiated.

If the corresponding situation is maintained for a given time without expiry of the reply time, the candidate may remain as being identified.

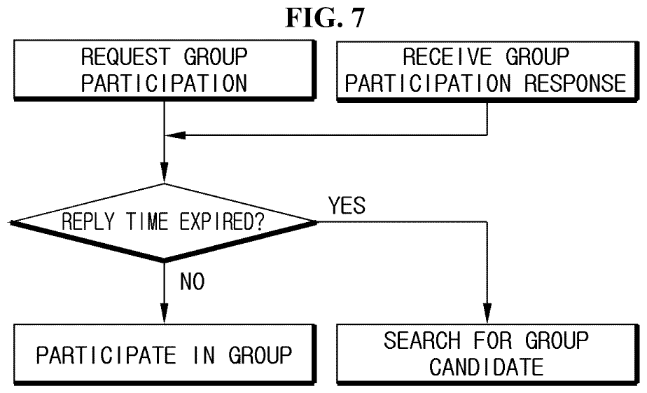

As described above, the group participation request step (S223) is a process of making a request for group participation to a target user having been identified as a group candidate; and as shown in FIG. 7, if a group participation response is received within the reply time, it may be determined that the corresponding target user will participate in the group.

When the reply time expires, it may be determined that the target user has no intention of participating in the chat group, and a search for a new group candidate may be initiated.

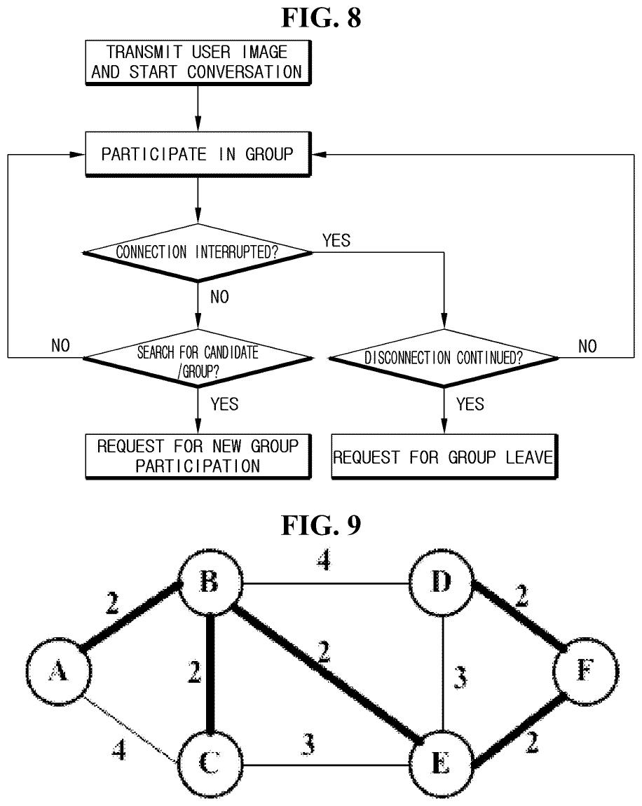

The group participation step (S224) is a process of maintaining, when group participation of the corresponding target user is identified through the previous process, the group participation of the corresponding target user based on the configured grouping condition; as shown in FIG. 8, in the process of conducting a conversation by transmitting and receiving image data to and from target users included in the corresponding chat group, a check may be performed on whether the connection with the corresponding chat group is maintained, whether the connection has been interrupted for a specific time, and whether a new group more suitable than the current chat group or new target user has been found, so that a request may be made to the corresponding target user to remain in the current chat group, leave the current chat group, or join a new group.

At this time, the group participation step (S224) may construct a minimum spanning tree corresponding to individual group members, check whether the edge count maintaining condition is satisfied with respect to the local user, and determine whether a specific target user remains in the group based on this.

To be more specific with this with reference to FIG. 9, a minimum spanning tree may be constructed in correspondence to individual target users (group users, remote users) belonging to the corresponding chat group. At this time, when constructing the minimum spanning tree, if the distance between target users is greater than a specific distance or there is an obstacle such as a wall between target users, it may be determined that they are not connected.

If the local user is connected to all target users by use of ‘n−1’ edges, it is possible to determine that the connection between the chat group and the local user is safe.

Here, ‘n’ refers to the number of users (including local user and target users) belonging to the corresponding chat group, and the edge refers to a line segment linking between individual users.

In addition, edges may be determined according to scores based on a preset calculation criterion; if the calculation criterion is the distance between users, the closer the two users are, the smaller the score becomes, and the farther away the two users are, the larger the score is; based on scores between users in the chat group, if the score between two users is the minimum, the two users may be linked by an edge.

The calculation criterion for assigning these scores is not limited to the distance between two users, and may also be given based on affiliation, rank, experience, or the like, and the scoring scheme for each criterion may be applied in various ways according to the needs of those skilled in the art.

These edges may be used to monitor whether a specific user remains in the corresponding chat group or forms a new chat group, and as described above, participation in a chat group may be determined based on whether the connection is made via an edge.

Consequently, if at least one of the target users moves far away and the number of edges does not reach ‘n−1’, it may be determined that the corresponding target user is disconnected from the chat group.

Further, whether a new candidate or group more suitable than the current group has been found may be determined using the following logic.

First, when the user with highest ‘candidate score’ among the users processed by the field-of-view logic as shown in FIG. 3 belongs to a specific chat group, if the barycenter of the chat group to which the local user belongs is closer than the barycenter of the specific chat group in the three-dimensional space, it may be determined that a suitable candidate (target user) has been found.

When not belonging to a specific chat group, if the location of the corresponding target user is closer than the barycenter of the chat group to which the local user belongs, it may be determined that a suitable candidate has been found.

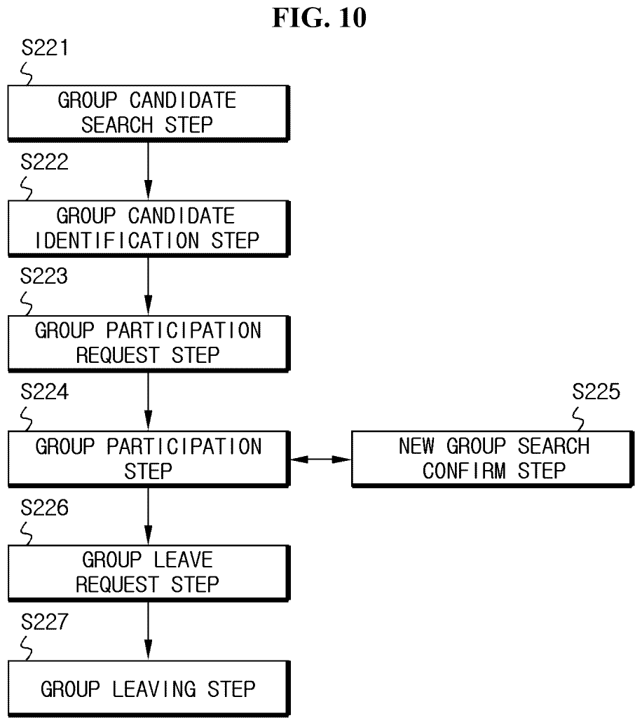

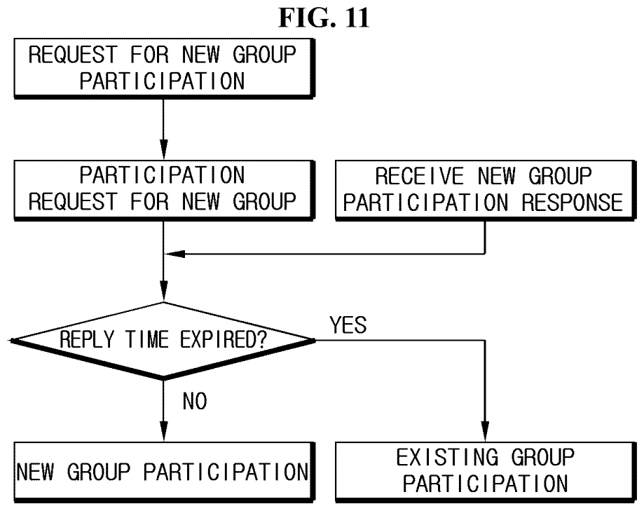

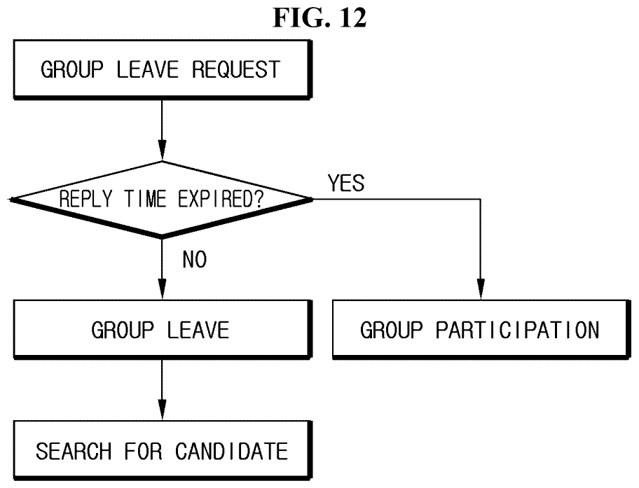

FIG. 10 is a flow diagram illustrating another embodiment of FIG. 4, and FIGS. 11 and 12 are diagrams describing FIG. 10 in more detail.

With reference to FIG. 10, the condition-specific grouping step (S220) may further include a new group search confirm step (S225), a group leave request step (S226), and a group leaving step (S227).

After confirming that a target user has found a more suitable group than the current group (S225), if the corresponding target user fails to satisfy the grouping condition of the current group or identifies a new group, it may make a request to leave the current chat group (S226), and may leave the current chat group according to the leave request (S227).

For example, as shown in FIG. 11, after making a request to participate in a new group to the server, if a response indicating new group participation is received within the reply time, it may be determined to be new group participation.

Thereafter, if the reply time expires after making a leave request to the current chat group, it may be determined as remaining in the current chat group; if the reply time does not expires, it may be determined as leaving the group and as searching for another candidate.

In describing specific embodiments of the user grouping method in a metaverse-based office environment according to the present disclosure, the description has been made with respect to the local user (self-user) or target user (other party, remote user), but without being limited thereto; the method described based on the local user may be applied on the basis of a target user, and vice versa.

The user grouping method in a metaverse-based office environment according to the present disclosure may be implemented as computer-readable code on a computer-readable recording medium.

Here, computer-readable recording media include all types of recording devices that store data that can be read by a computer system. For example, computer-readable recording media may include ROM, RAM, CD-ROM, magnetic tape, floppy disk, optical data storage, or the like.

In addition, computer-readable recording media may be distributed in computer systems connected over a network, so that the computer-readable code can be stored and executed in a distributed manner.

In addition, the functional programs, codes, and code segments for implementing the present disclosure may be easily deduced by programmers in the art to which the present disclosure belongs.

In addition, a person skilled in the art will understand that the technical configuration of the present disclosure can be implemented in various specific forms without changing the technical idea or essential features of the present disclosure.

Therefore, the embodiments described hereinabove should be understood as being illustrative in all respects and as not being limited.

### Industrial Applicability

The present disclosure can be used not only in the metaverse field, virtual reality field, and virtual office field, but also in similar or related fields, and can improve reliability and competitiveness in the corresponding field.

1. A method for grouping users in a metaverse-based office environment, the method comprising:
a target user identification step of identifying a camera viewpoint of a local user in a virtual space and identifying target users included in a virtual image of the corresponding camera viewpoint; and
a user grouping step of grouping those target users satisfying a configured grouping condition among the target users based on an avatar position and gaze direction of the local user.

2. The method of claim 1, wherein the user grouping step comprises:
a field-of-view identification step of identifying a field of view based on the avatar position and gaze direction of the local user; and
a condition-specific grouping step of grouping those target users satisfying the configured grouping condition among the target users included in the field of view.

3. The method of claim 2, wherein the field-of-view identification step comprises:
a user list generation step of making a list of target users included in a current virtual image;
a group formability check step of checking whether the target users included in the list are included in a group;
a presence within gaze check step of checking whether a corresponding target user is present within the gaze direction and region of the local user;
an object interference check step of checking interference caused by an object in the virtual space;
a group inclusion check step of checking whether the corresponding target user belongs to a group together with the local user or has left a group; and
a descending order sorting step of performing sorting the target users in descending order according to the cosine similarity between a vector formed by the location of the corresponding target user and the location of the local user, and a vector viewed by the local user.

4. The method of claim 2, wherein the condition-specific grouping step comprises:
a group candidate search step of searching for target users to be included in a chat group;
a group candidate identification step of identifying a corresponding target user based on the search results of the group candidate search step;
a group participation request step of making a group participation request to a target user being a corresponding group candidate; and
a group participation step of maintaining, when group participation of the target user is identified, the group participation of the corresponding target user based on the configured grouping condition.

5. The method of claim 4, wherein:
the group candidate identification step searches for a target user by checking whether the target user is present within the gaze of the local user; and
the group candidate identification step identifies, in case that a target user is present within the gaze of the local user, the target user as a group candidate.

6. The method of claim 5, wherein the group participation step constructs a minimum spanning tree by use of the local user and target users, checks whether an edge count maintaining condition is satisfied with respect to the local user, and determines whether a specific target user remains in the group based thereon.

7. The method of claim 4, wherein the condition-specific grouping step further comprises:
a new group search confirm step of confirming that a corresponding target user has found a more suitable group than the current group;
a group leave request step of making, in case that the corresponding target user fails to satisfy the grouping condition of the current group or has identified a new group, a request to leave the current chat group; and
a group leaving step of leaving the current chat group in response to the leave request.

8. A storage medium in which a program for executing the method for grouping users in a metaverse-based office environment as described in claim 1 is recorded.

9. A system for grouping users in a metaverse-based office environment, including the storage medium of claim 8.
